(19) United States
(12) Patent Application Publication
(10) Pub. No.: US 2019/0308721 A1
(43) Pub. Date: Oct. 10, 2019

(54) INTEGRATED SMART SENSING SYSTEMS AND METHODS

(71) Applicant: LORD Corporation, Cary, NC (US)

(72) Inventors: Daniel KAKALEY, Cary, NC (US); Russell ALTIERI, Holly Springs, NC (US); Conor MARR, Erie, PA (US); Douglas SWANSON, Cary, NC (US); Mark JOLLY, Raleigh, NC (US); David CHURCHILL, Burlington, VT (US)

(21) Appl. No.: 16/340,175

(22) PCT Filed: Oct. 31, 2017
(86) PCT No.: PCT/US2017/059316

§ 371 Date: Apr. 8, 2019

Related U.S. Application Data
(60) Provisional application No. 62/415,019, filed on Oct. 31, 2016.
(60) Provisional application No. 62/452,465, filed on Jan. 31, 2017.

(51) Int. Cl. B64C 27/00; B64C 27/57

(52) U.S. Cl. CPC B64C 27/008; B64C 27/57

(57) ABSTRACT

Rotary motion sensing systems are well-suited for integration in a bearing system of a rotary aircraft to provide information about the operational state of the rotor blades of the aircraft. In some embodiments, sensors are positioned on lateral sides of an elastomeric bearing system and output signals which may be processed to calculate one or more rotor blade operational states. The operational states include, for example, flap angle, lead-lag angle, and pitch angle. In other embodiments, sensors may be distributed along at least a portion of the length of a rotor blade to detect deflection of the rotor blade or its impact with another object. The operational state of the rotor blades may be transmitted to the pilot and/or the flight control computer of the aircraft in order for corrective action to be taken and/or may be stored within a control box for later review.

### CROSS-REFERENCE TO RELATED APPLICATIONS

This application claims the benefit of U.S. Provisional Patent Application Ser. No. 62/415,019 filed Oct. 31, 2016, the disclosure of which is incorporated herein by reference in its entirety. This application also claims the benefit of U.S. Provisional Patent Application Ser. No. 62/452,465 filed Jan. 31, 2017, the disclosure of which is incorporated herein by reference in its entirety.

### TECHNICAL FIELD

The subject matter disclosed herein relates generally to the design and operation of motion control bearings for rotorcraft. More particularly, the subject matter disclosed herein relates to real-time sensing of rotor states (e.g., motions, forces, and torques) of such rotorcraft and the processing and storage of such rotor states for monitoring both flight condition monitoring and health monitoring of rotor system and rotorcraft.

### BACKGROUND

Some rotorcraft (e.g., helicopters) have very flexible rotors and can experience excessive blade motions (e.g., flap angle, lead-lag angle, and/or pitch angle) as well as extreme blade bending deflections and angles which can lead to undesirable effects. In modern design and control of rotorcraft, it is advantageous to be able to detect operational characteristics of a rotor system and to apply corrective action, when necessary. Current designs rely on indirect detection of the operational states of the rotor blades of a rotorcraft, examples of such indirect detection including magnetic sensing devices used to detect fluctuations in magnetic fields caused by movement of one or more magnets relative to a magnetometer. As such, it would be advantageous to enable direct measurement of the rotor blade state in real-time. Furthermore, it would be advantageous to integrate embedded sensors within the structures of the rotorcraft in order to enable the real-time monitoring of the rotor blade states. This real-time monitored data can then be processed and transmitted to the operator of the rotorcraft, the flight control computer of the rotor craft, and/or stored in a data logger for later analysis and review. Furthermore, monitoring of the rotor motions and locations where a rotor may strike against another structure of the helicopter may be avoided by identifying dangerous maneuvers and motions of the rotors and taking corrective action.

### SUMMARY

The presently disclosed subject matter is related to sensing performance aspects of the rotors of an aircraft, specifically a rotorcraft.

According to one aspect of the present invention, a method for sensing motion in a rotary aircraft is provided, the method comprising or including distributing one or more sensors within a rotating hub and/or rotor blade, transmitting output values from the one or more sensors to a controller, and computing an aspect of movement for the rotor blade using the output values.

According to another aspect, a distributed sensing system for detecting blade motion on an aircraft having a plurality of rotor blades is provided, the system comprising a plurality of sensors associated with each of the plurality of rotor blades, each of the plurality of sensors being configured to detect motion in a respective rotor blade, and a controller configured to receive signals from the plurality of sensors and in electronic communication with the flight control system across a data bus of the aircraft.

Another aspect of the invention provides a sensor system for detecting an aspect of movement across an articulating joint, the system comprising a rotary hub, a plurality of rotor blades, at least one first sensor disposed on a first side of the rotary hub and configured to generate a first output signal, at least one second sensor on a second side of the rotary hub and configured to generate a second output signal, and a control box in electrical communication with the at least one first and second sensors to a data bus.

Yet another aspect provides a sensor system for measuring motion across an articulating joint including a plurality of members with an articulation device therebetween, the sensing system comprising at least three motion measuring devices affixed to each of the plurality of members and proximal to the articulation device, the at least three motion measuring devices each being configured to create a respective output signal, and a control box in electronic communication with the at least three measuring devices and configured to receive the output signal from each of the at least three motion measuring devices, wherein the control box is configured to process and combine the respective output signals and resolve three degrees-of-freedom of articulation.

Still another aspect of the invention provides a sensing system comprising a plurality of sensors in a rotating and/or fixed frame, each of the plurality of sensors being configured to synthesize sensor data, and a control box in electronic communication with the plurality of sensors and configured to receive the synthesized sensor data, wherein the controller is configured to use the sensor data to determine an orientation of at least one rotor blade.

Another aspect of the invention provides a blade motion and load detection system comprising a rotary wing aircraft comprising a rotary hub, a plurality of rotor blades, at least one bearing system configured to provide articulation between the rotor hub and each of the plurality of rotor blades, a data transfer system, and a flight control system; and a distributed sensing system comprising at least one sensor in at least one of the at least one bearing system, the at least one sensor being configured to detect load and/or motion, a control box configured to receive signals from the at least one sensor, a database configured to store the signals received, and a communication bus configured to communicate data from the control box to the flight control system.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1A is an example schematic embodiment of an embedded sensing system architecture in accordance with the disclosure herein.

FIG. 1B is an example schematic embodiment of a distributed sensing system architecture with sensors distributed along the length of a rotor blade in accordance with the disclosure herein.

FIG. 1C is a top view of an example schematic embodiment of a blade monitoring system in accordance with the disclosure herein.

FIG. 2A is a schematic example embodiment of a sensing system embedded in a bearing system of a helicopter in accordance with the disclosure herein.

FIG. 2B is a schematic example embodiment of an integrated sensing system with distributed sensors in a helicopter in accordance with the disclosure herein.

FIG. 3 is cut-away view of a single bearing with embedded sensing according to an embodiment of the disclosure herein.

FIG. 4 is a cross-sectional view of a configuration of an embodiment of a coupled bearing system in accordance with the disclosure herein.

FIG. 5 is a cross-sectional view of a second configuration of an embodiment of a coupled bearing system with embedded sensors in accordance with the disclosure herein.

FIG. 6 is a cross-sectional view of an embodiment of a smart bearing system with differential accelerometers for motion sensing in accordance with the disclosure herein.

FIG. 7A is a schematic rotary motion diagram of a rotor blade with accelerometers present adjacent the blade root in accordance with the disclosure herein.

FIG. 7B is a schematic rotary motion diagram of a rotor blade with multiple sensors spaced along the length of the blade in accordance with the disclosure herein.

FIG. 8 is a schematic diagram of all blade motions at the blade root in accordance with the disclosure herein.

FIG. 9 is a schematic rotary motion diagram for an embodiment having differential accelerometers in accordance with the disclosure herein.

FIG. 10 is a set of graphs illustrating simulation data, plotting accelerometer measurement values as a function of blade flap angle at accelerometer location 2 in accordance with the disclosure herein.

FIG. 11 is a picture of a helicopter test bracket mounted on a helicopter fuselage and used to spin accelerometers for empirical validation in accordance with the disclosure herein.

FIG. 12 is a picture of a depth gauge being used to measure accelerometer angles during empirical validation on a helicopter fuselage in accordance with the disclosure herein.

FIG. 13 is a table showing a summary of empirical validation data in accordance with the disclosure herein.

FIG. 14 is a set of graphs illustrating empirical data obtained from the helicopter test bed illustrated in FIGS. 11-12, plotting accelerometer measurement values as a function of blade flap angle at accelerometer location 2 in accordance with the disclosure herein.

FIG. 15 is a cross-sectional view of an embodiment of a smart bearing system with displacement sensors embedded therein in accordance with the disclosure herein.

FIG. 16A is a cross-sectional view of a single rotor bearing with a magnetometer incorporated therein for motion sensing in accordance with the disclosure herein.

FIG. 16B is a cross-sectional view of a bearing system including multiple bearing structures, with a magnetometer incorporated in the bearing structures for motion sensing in accordance with the disclosure herein.

FIG. 17 is a cross-sectional view of a single rotor bearing with a plurality of strain gages embedded therein for detecting loads transmitted through the bearing in accordance with the disclosure herein.

FIG. 18 is a perspective view of an example control box according to an embodiment of the smart sensing architecture in accordance with the disclosure herein.

FIG. 19A is a cross-sectional view of an example bearing illustrating embedded sensing using accelerometers in accordance with the disclosure herein.

FIG. 19B is a cross-sectional view of an example bearing illustrating embedded sensing using magnetic sensors in accordance with the disclosure herein.

FIG. 20A is a cross-sectional view of an example fluid-elastic damper with embedded sensing in accordance with the disclosure herein.

FIG. 20B is a cross-sectional view of an example fluid-elastic pylon isolator with embedded sensing in accordance with the disclosure herein.

FIG. 21 is a schematic diagram illustrating an example helicopter with integrated embedded sensors and distributed sensors in accordance with the disclosure herein.

### DETAILED DESCRIPTION

The presently disclosed subject matter addresses the problems encountered in conventional rotor state sensing architectures found in existing rotorcraft by enabling direct real-time measurement of the forces and torques acting on the components of the rotor system, as well as monitoring, in some embodiments, relative displacement of the components of the rotor system.

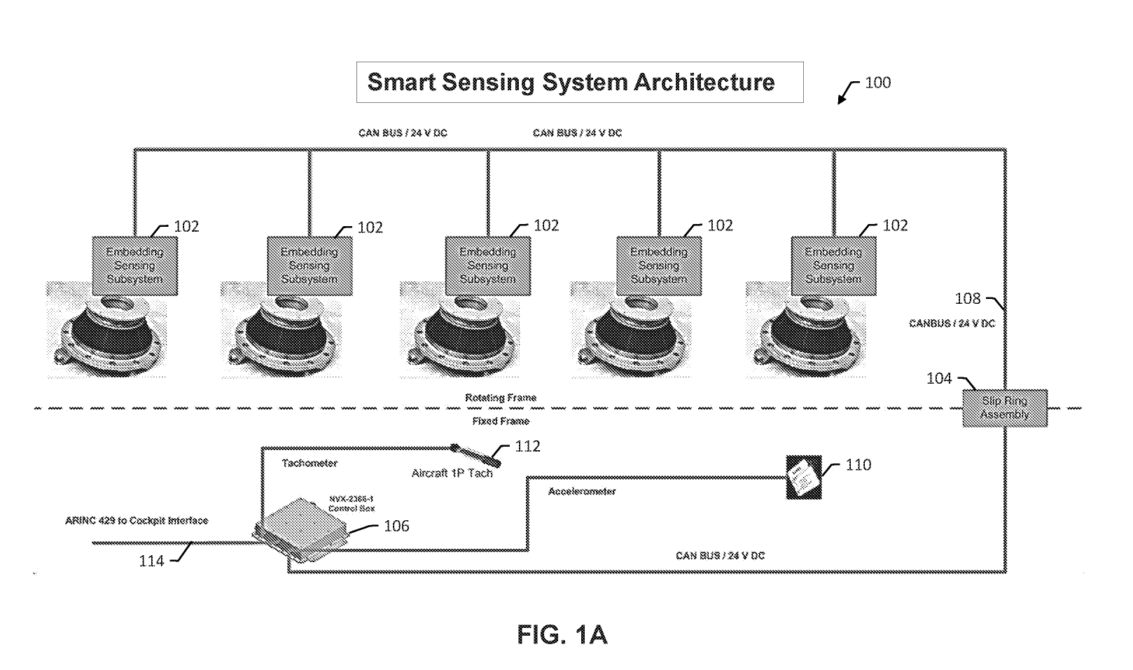

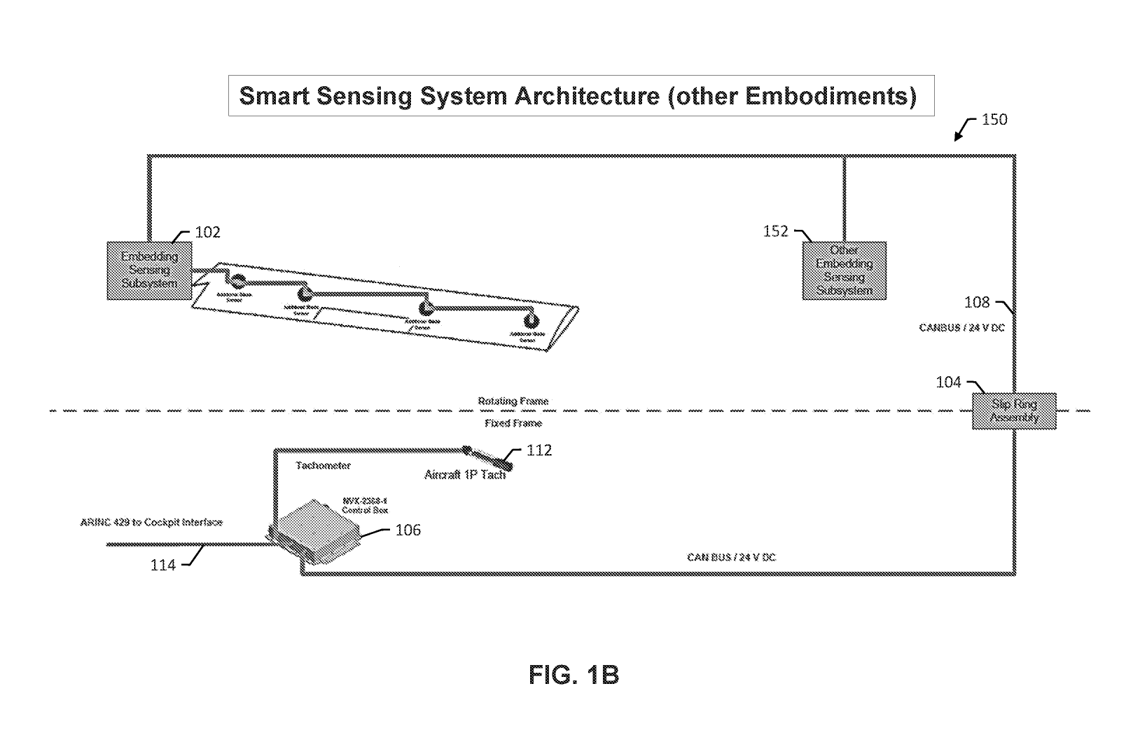

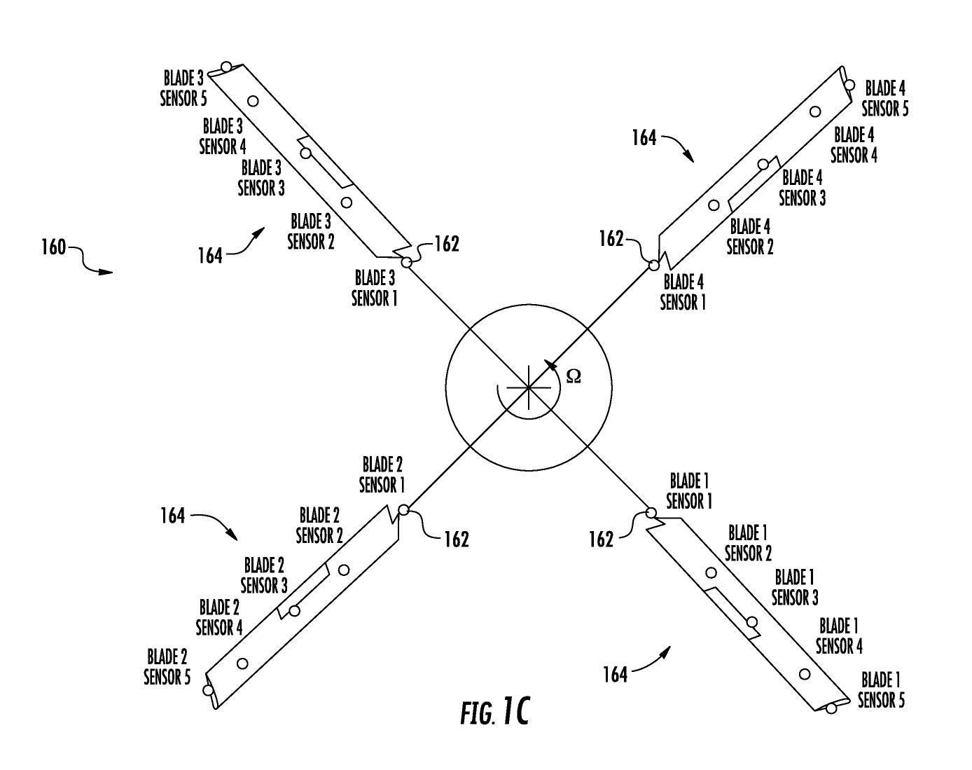

Referring to FIGS. 1A and 1B, embodiments of embedded sensing system architectures 100 and 150 according to the present subject matter are illustrated. In the illustrated embodiment of FIG. 1A, a smart sensing system architecture 100 includes one or more sensing subsystems 102 (e.g., elastomeric bearing structures with one or more sensors embedded therein), a slip ring assembly 104, a control box 106, a communication system 108 (e.g., CAN bus) between the bearings and the control box, additional fixed frame sensors 110 and 112, and a communication interface 114 (e.g., ARINC 429 to cockpit interface) between the control box 106 and the aircraft. The embedded sensing, as shown in FIGS. 1A and 1B, is incorporated into the rotor system in an architecture configured as is shown, being configured for data collected to be sent through a slip ring 104 and the control box 106. The system 150 shown in FIG. 1B illustrates an architecture with one or more other embedded sensing subsystems 152.

Additional fixed frame sensors (e.g., a 1/rev tachometer 112 or accelerometer 110) can be placed on the aircraft to obtain further monitoring data of blade strike or foreign body impact events. For example, a 1/rev tachometer 112 may be provided adjacent the rotating frame to measure a magnet or metallic feature one every revolution of the rotor blade; one reason for this would be to provide information upon, a rotor blade strike event occurring, as to which rotor blade struck the aircraft structure (e.g., a structure adjacent to the path of rotation of the rotor blade). According to an example embodiment, an accelerometer 110 may be mounted on or around the surrounding structure of the path of rotation of the rotor blade which, based on the magnitude and frequency content of the signal from accelerometer, could determine if a blade strive event occurred; because a blade strike event acts as an impulsive load, such an event would result in excitation of the natural frequencies of the surrounding structure to which the accelerometer is mounted.

FIG. 1C is a top view of a more generic system 160 with distributed sensors being located at the rotor root (root sensors 162) as well as along the length of the rotor (other sensors 164). In some embodiments, the embodiments described herein can include various sensors configured to take inertial measurements and/or measure the actual position and orientation of the blade along its span.

It should be noted that such smart differential and/or distributed sensing systems are not limited to embodiments embedded within elastomeric bearings. For example, next generation rotorcraft have bearing-less designs, in which case sensors may be placed along or within the blade itself rather than in a bearing supporting the blade.

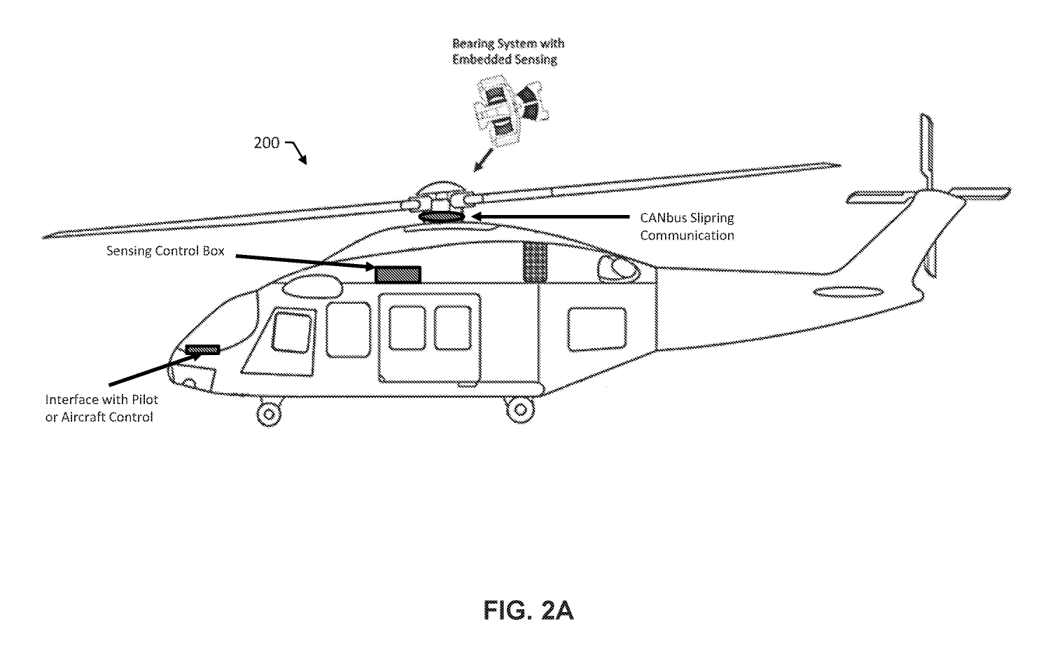

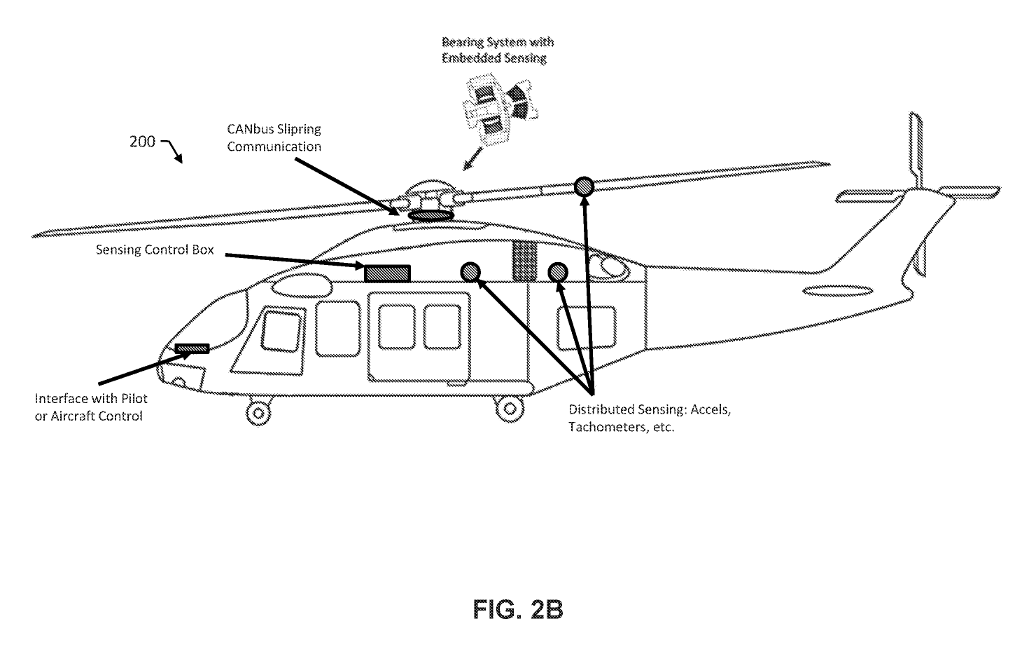

FIGS. 2A and 2B show an example of placement and integration into an aircraft 200 for both the simpler smart sensing system and the more elaborate distributed sensing system, respectively. In addition to the embedded sensing in the rotor bearings, distributed sensing can provide further information. This includes the use of accelerometers, temperature sensors, strain gages, magnetometers, torque sensors, and tachometers. These sensors can be in both the rotor frame and the body frame to provide additional aircraft data to identify various operational states of the rotors and the aircraft. Distributed accelerometers can be configured, for example, to detect vibrations or blade impacts. Tachometers or torque sensors can be configured, for example, to monitor rotor speed and torque. Magnetometers can be configured, for example, to detect the magnetic field in reference frames related to the embedded sensing for use in removing unwanted magnetic signals. Temperature sensors can be can be configured, for example, to measure temperature conditions before, during, and after flight.

The data collected by the embedded sensing system in the bearings is communicated to the central control box via the CAN bus communication 108 over a slip ring 104. The use of a multitude of power channels and a multitude of signal channels allow for reliable communication of data. The power channels come from the control power to ensure regulated DC power. The CAN bus connection 108 allows communication with the bearings at high data rates.

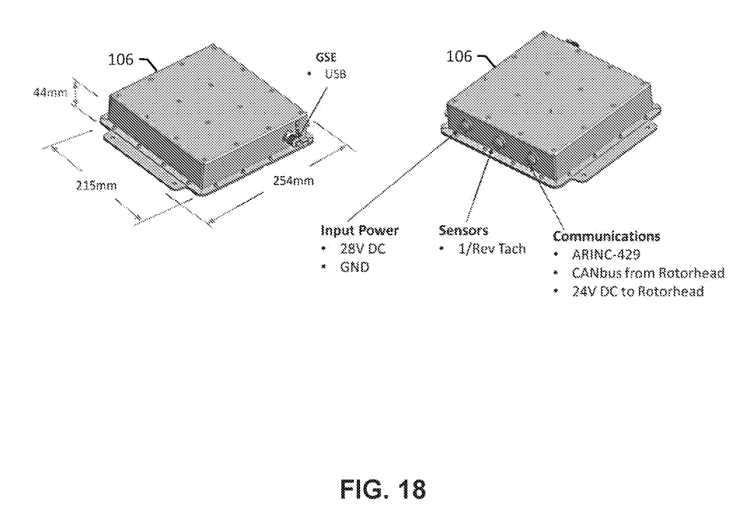

The blade data sent through the slip ring 104 will be collected by the central control box 106, an example of which is illustrated in FIG. 18. The control box 106 can store data directly, store data based on a defined trigger event and/or communicate with the aircraft after conducting some processing of the data.

In one embodiment, the control box 106 can detect “limit” motions and store data encompassing the event. A buffer can be used to store data in a defined time leading up to, during, and after the event triggered by the occurrence of the limit motion. This data can be used immediately to communicate to the flight control computer and/or the pilot of the aircraft that one or more limits have been exceeded, or can be stored and analyzed or communicated at a later time.

When communicating with the aircraft, data from all bearings, from a subset of bearings, from a single bearing, from the distributed sensors, or any combination of the attached sensing systems can be communicated in raw form or in processed form, such as where some logic has been applied to the data before communication to the flight control computer. In one example, a series of limits, when all exceeded, can trigger a signal that will send an alert to the aircraft that a given flight condition has been entered.

Multiple triggers can be used and incorporated together in logic to detect a variety of events using the data collected from both the embedded and distributed sensors.

Data recorded in the control box 106 can be time referenced in at least two different ways. The control box 106 can synchronize to an absolute time signal from the aircraft to ensure that the event data can be linked back to control data stored by the aircraft following the flight. The control box 106 can also timestamp data relative to the time that the control box 106 was first powered.

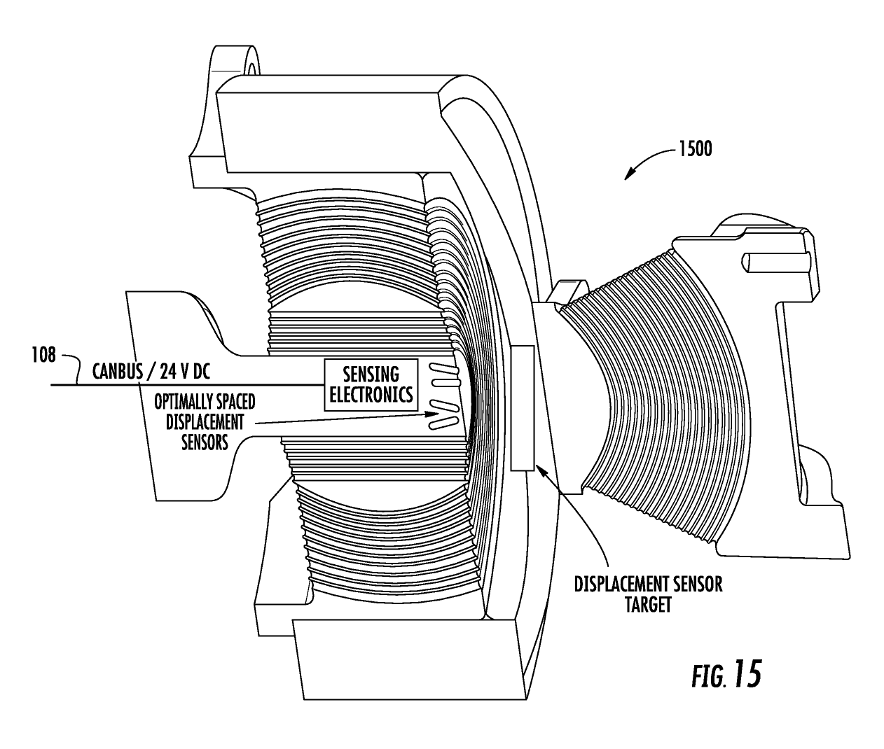

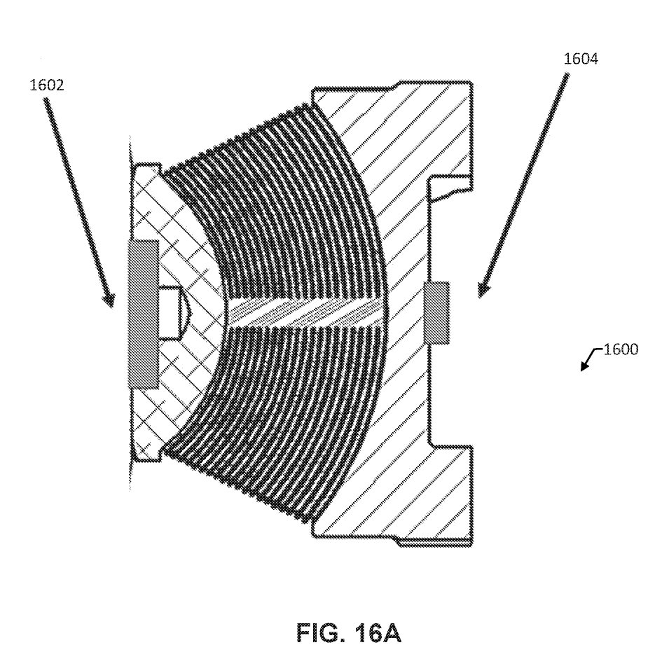

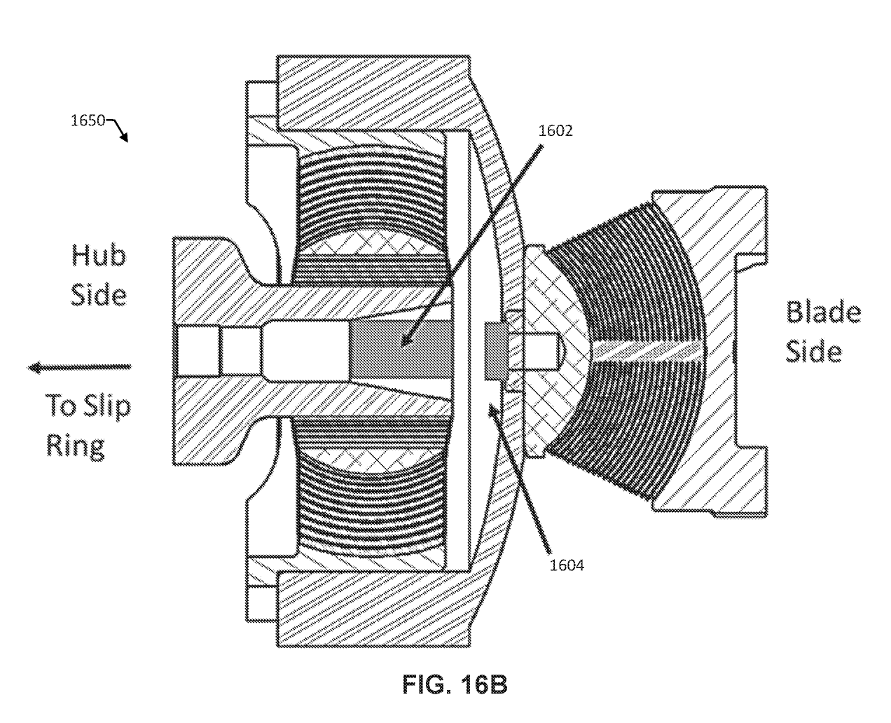

The control box 106 can include a dedicated USB connector to provide communication with any standard PC computer. The USB connector is capped during normal flight operations. Note that the location of the USB connector on the enclosure can be selected during the product design phase to provide the most convenient access by maintenance personnel. The control box 106 can also include, in addition to or in place of the USB connector, a wireless data transfer system. A diagram of an example enclosure is contained in FIG. 16.

In addition to the embedded sensing in the rotor bearings, distributed sensing can provide further information, which can be stored or used in the management and control of the aircraft. This distributed sensing can include accelerometers, temperature sensors, strain gages, magnetometers, torque sensors, and tachometers. Such sensors can be in both the rotor frame and the body frame to help provide additional aircraft data to identify states. Distributed accelerometers can help to detect vibrations or blade impacts. Tachometers or torque sensors can be used to monitor the rotor speed and torque. Magnetometers can be used to detect the magnetic field in reference frames related to the embedded sensing for use in removing unwanted magnetic signals. Temperature sensors can be used to measure temperature conditions before, during, and after flight.

The control box 106 can interface with the aircraft 200 in a variety of ways. In one example, output signals over the ARINC-429 bus 114 can communicate information directly to the flight computer or aircraft control system. Signals coming from the control box 106 can be used to alert the pilot directly by, for example, a visual indicator or haptic feedback, which can be used to alter parameters in the aircraft flight control system, can be communicated externally from the aircraft, and/or can be stored externally from the control box 106. In addition to a visual sign, other signals, such as tactile or auditory feedback can be used to provide an indication to the pilot.

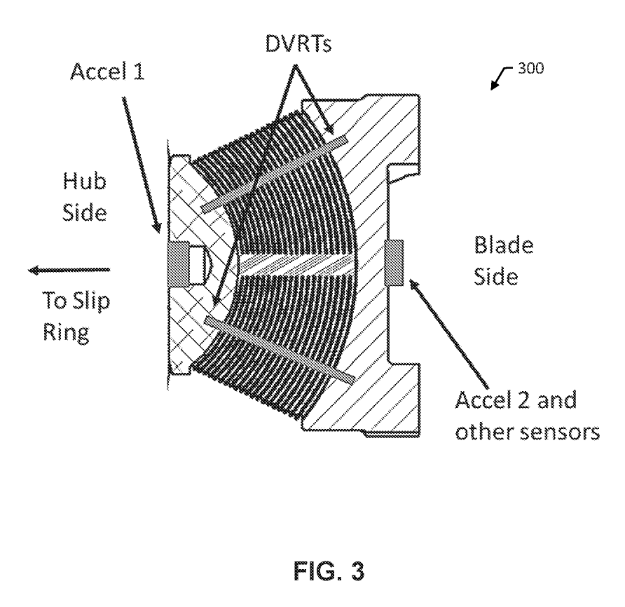

Such embedded sensing systems incorporate sensors into an elastomeric rotor bearing which attaches a rotor blade to the hub. FIG. 3 shows an embodiment where such sensors are embedded within a single elastomeric bearing 300. Multiple sensors are embedded within the rotor bearing structure for the embodiments which utilize differential measurements. For example, where the flap angle is being measured, the accelerometers (Accel 1 and Accel 2) will be placed on opposite sides of the bearing, with one on the rotor blade side and the other placed on the hub side of the bearing. Similarly, where DVRTs are included, they may be embedded at angles to each other, as shown in FIG. 3.

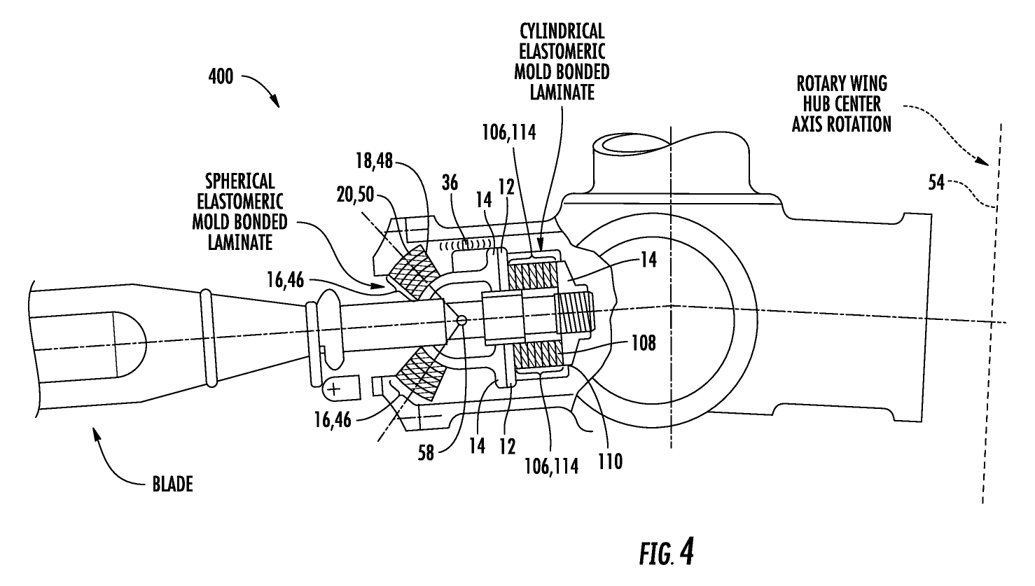

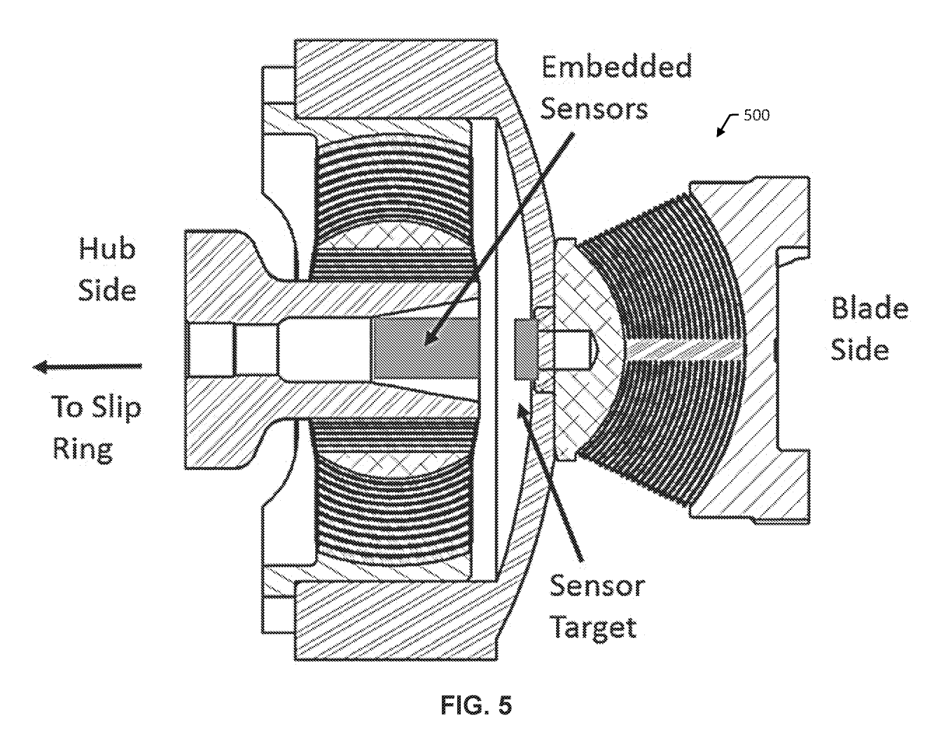

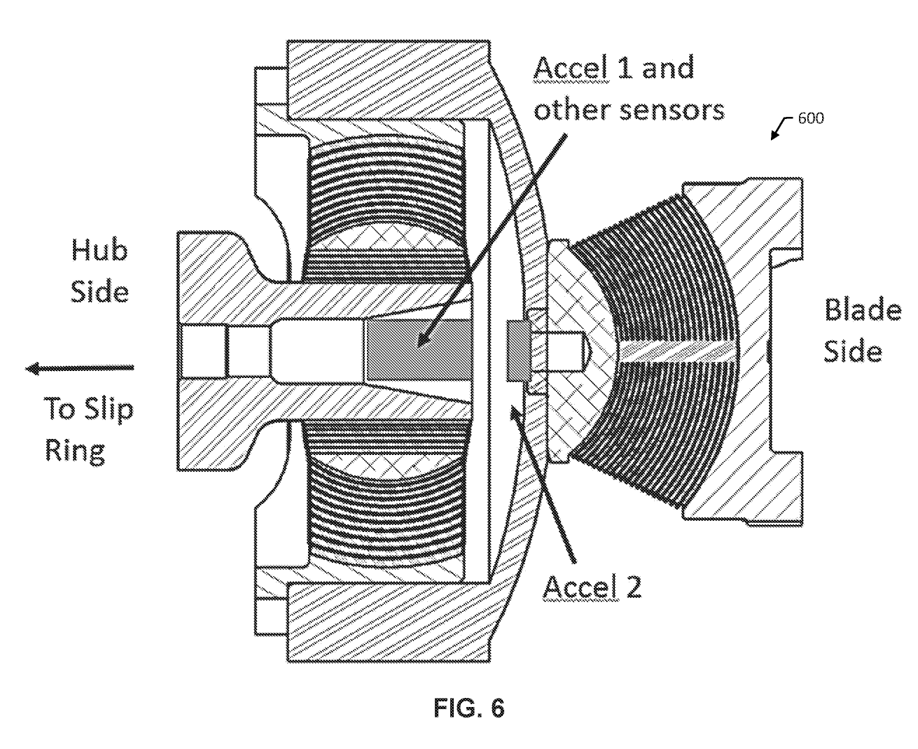

FIGS. 4, 5, and 6 show example embodiments 400, 500, and 600 where sensors are embedded in a series of bearings that couple together to allow for monitoring at least one or more aspect of movement (e.g., flap angle, lead-lag angle, and/or pitch angle) of a rotor blade of a rotorcraft. The coupled bearing system can be in multiple configurations, but in all cases the elastomeric bearings serve the same purpose to take centrifugal (axial), flap and lead-lag (radial) loads while providing compliance in the flap, lead-lag, and pitch motions. In some configurations 500 and 600 the hub is attached to either end of the bearing system as in FIGS. 5 and 6, or it is connected only to one end as in the configuration 400 of FIG. 4. This sensing system can include accelerometers, contactless DVRTs, magnetometers, strain gages, piezo-electric sensors, or any combination of these. The contactless DVRTs, accelerometers, and magnetometers measure displacement, either across a single bearing or across the entire bearing system. The strain gages and piezo electric sensors measure load across the bearing or bearing system.

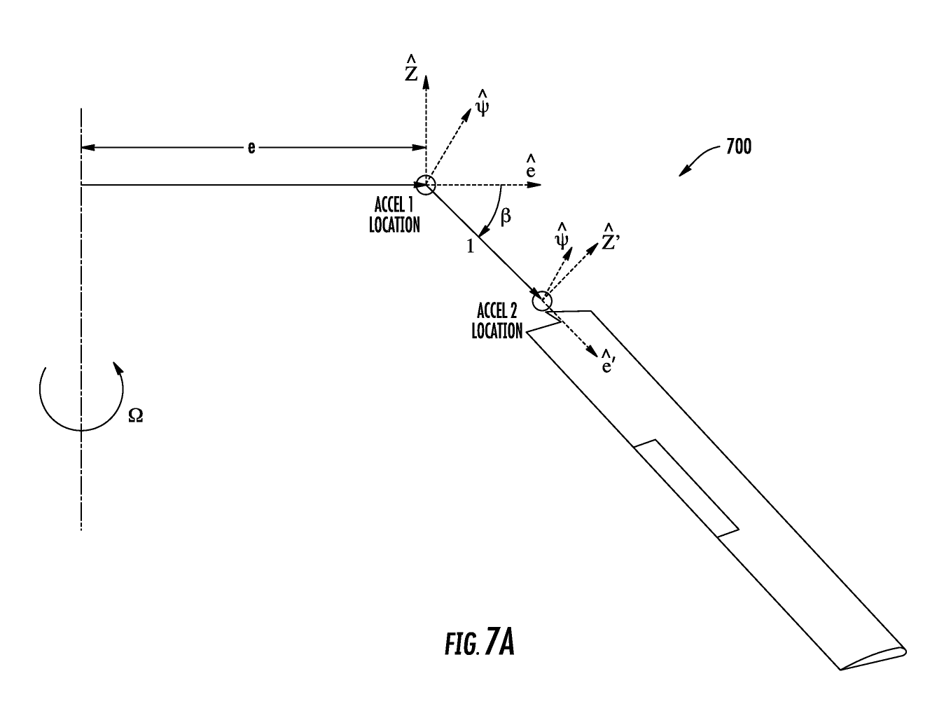

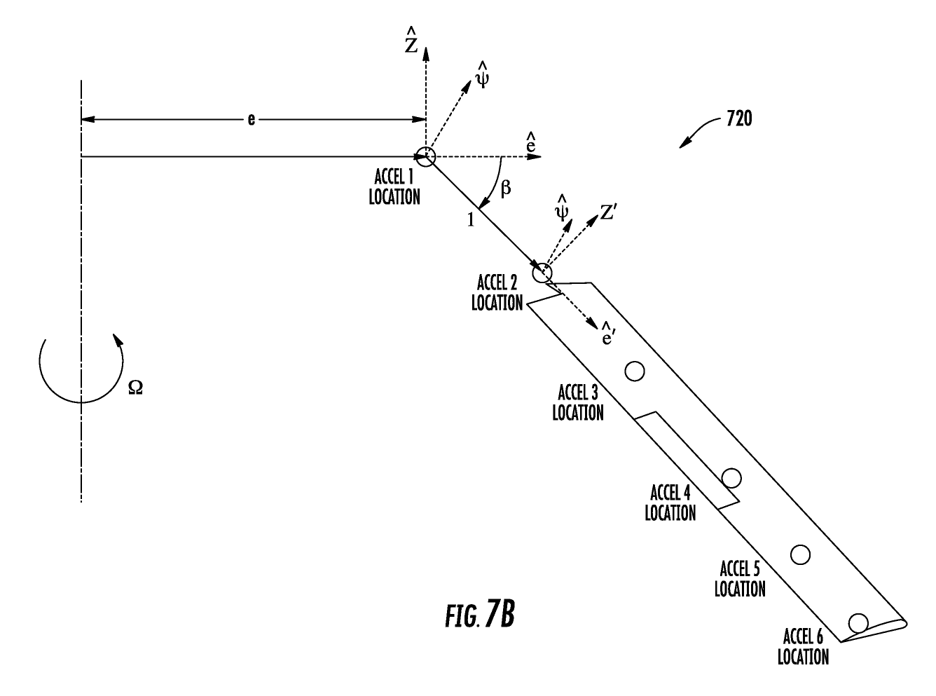

According to the force and motion diagram 700 for an embodiment shown in FIG. 7A, two accelerometers are embedded within a bearing system and the differential acceleration between two or more accelerometers is used to determine the flap or lead-lag angle of a rotor blade. One or more accelerometers is located on the stationary (e.g., hub) side of the bearing system and one or more accelerometers would be located on the rotating (e.g., blade) side of the bearing system. The accelerometer at “Accel 2 Location” can be used to model the motion of the rotor blade using a system model of the rotor blade. The differential acceleration readings between the stationary and moving side of the bearing system allow for calculation of the flap or lead-lag angle.

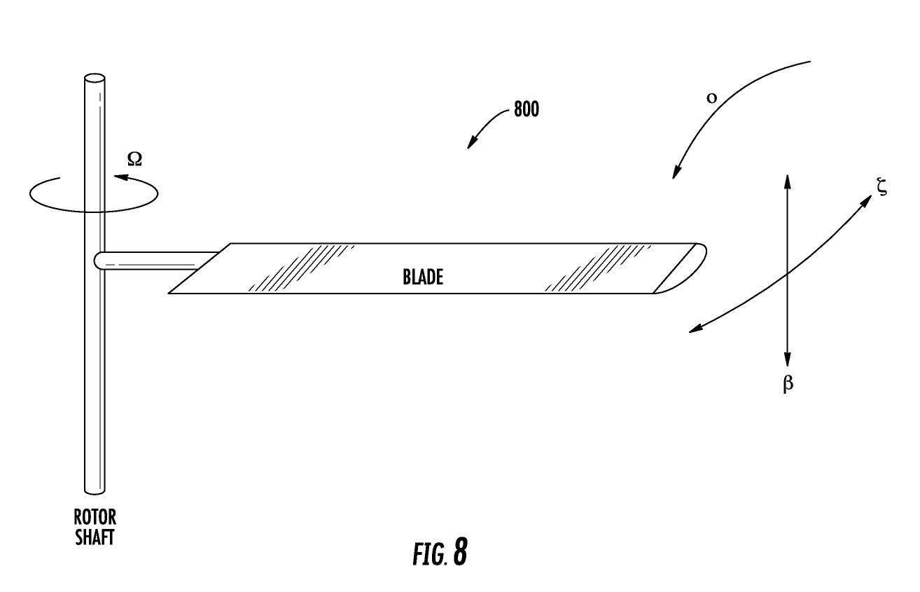

Additionally, sensors can be placed at various locations along the rotor blade to obtain further accuracy in modeling, as is illustrated in the diagram 720 of FIG. 7B. The method of using accelerometers is also applicable to multiple axes of blade motion (e.g., radial displacement and flap, pitch, and lead-lag angles), as is shown in the diagram 800 of FIG. 8. It should be noted that the sensors illustrated in FIGS. 7A-7B are not necessarily limited to accelerometers, but include, for example, inertial measurement units (IMUs) in one or more sensing location. IMUs can contain multiple accelerometers and gyroscopes which, when synthesized with a processor, can provide an improved measurement of the blade orientation (as compared to just accelerometers). The IMUs may be configured to measure flap, lead-lag, and pitch motion. The IMUs would approximate the orientation of the blade so that at each sensor location information about the overall shape of the blade would be obtained. In addition, the aforementioned method of using accelerometers could be extended to multiple axes of blade motion (e.g., radial displacement, flap, pitch, and lag) as shown in FIG. 8.

Regarding FIG. 8, β is the blade flap angle, which is a degree of freedom which produces rotor blade motion and which is defined to be positive for upward movement of the rotor blade (e.g., produced by blade thrust forces). ζ is the blade lead-lag angle, which is a degree of freedom that produces blade motion and which is defined to be positive when oriented opposite to the direction of rotation of the rotor (e.g., produced by blade drag forces). θ is the blade pitch angle (e.g., feathering motion) produced by rotation of the blade about the rotor shaft; positive blade pitch occurs when nose-up rotation of the blade is present. The degrees of freedom β, ζ and θ can also be contemplated as rotations of the respective rotor blade relative to hinges at the base of the rotor blade, with the following axes of rotation: β is the angle of rotation perpendicular to the plane defined by the plane of rotation; ζ is the angle of rotation parallel to the rotor shaft; and θ is the angle of rotation about an axis parallel to the length of the rotor blade.

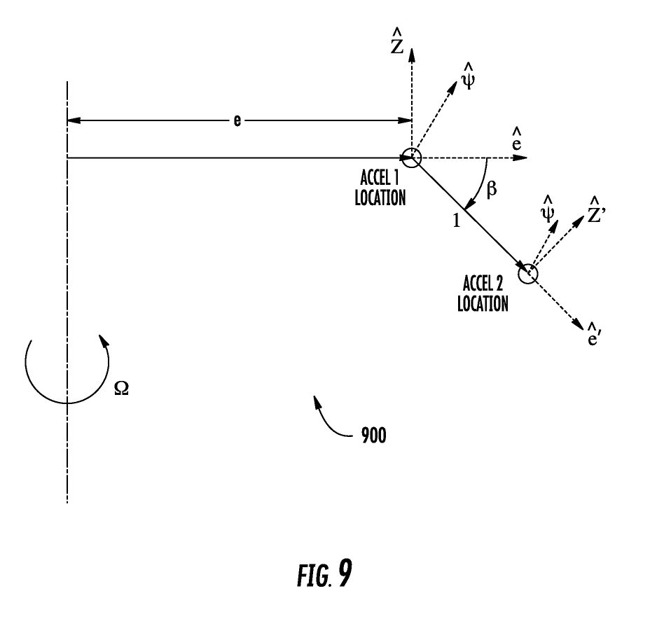

An example of how the calculation for flap angle can be derived will be discussed further hereinbelow, with reference to FIG. 9, which provides a sample diagram 900 of accelerometer orientations. While this example focuses on the flap angle measurement, it is equally applicable to the lead-lag direction.

The rotation of the rotor hub is occurring at an angular speed denoted by Ω. The first accelerometer is located a radial distance e away from the center of the hub's rotation. As shown in FIG. 9, this vector \vec{e} is continually rotating in and out of the page. The flap angle is denoted by β and indicates how much the blade has “drooped” relative to \vec{e}. The second accelerometer is placed in the “prime” frame which is undergoing flap motion.

If the base of \vec{e} (e.g., at the center of rotation of the rotor hub) is denoted as point “0”, the acceleration at this center of rotation can be denoted as \vec{a₀}).

The acceleration at the first accelerometer's location can then be defined as \vec{a₁}, and can be related to \vec{a₀} with the following vector equation: \vec{a₁}=\vec{Ω}×(\vec{Ω}×\vec{e})+\vec{a₀}).

If the vector equation is solved with parameters defined in FIG. 9, the following simplifications can be made: \vec{a₁}=Ω\hat{z}×(Ω\hat{z}×eê)+\vec{a₀}=Ω\hat{z}×(eΩ\hat{ψ})+\vec{a₀}, which can be further simplified to \vec{a₁}=−eΩ²ê+\vec{a₀}.

In addition, the acceleration at the second accelerometer's location can be defined as \vec{a₂}, and can be related to \vec{a₀} with the following vector equation: \vec{a₂}=\vec{Ω}×(\vec{Ω}×\vec{l})+\vec{a₁}.

To define \vec{l}, a rotation matrix from the first accelerometer's reference frame to the second accelerometer's reference frame is needed. Based on the reference frames defined in FIG. 9, the following rotation matrix can be deduced:

$$[ \begin{matrix}{\hat{e}}^{′} \\ \hat{ψ} \\ {\hat{z}}^{′}\end{matrix} ] = [ B ] [ \begin{matrix}\hat{e} \\ \hat{ψ} \\ \hat{z}\end{matrix} ] = [ \begin{matrix}cos ( β ) & 0 & - sin ( β ) \\ 0 & 1 & 0 \\ sin ( β ) & 0 & cos ( β )\end{matrix} ] [ \begin{matrix}\hat{e} \\ \hat{ψ} \\ \hat{z}\end{matrix} ]$$

Also, it should be noted that [B]^{T} (the transpose) is equal to [B]⁻¹ (the inverse), allowing the following to be quickly defined:

$$[ \begin{matrix}\hat{e} \\ \hat{θ} \\ \hat{z}\end{matrix} ] = {[ B ]}^{- 1} [ \begin{matrix}{\hat{e}}^{′} \\ \hat{ψ} \\ {\hat{z}}^{′}\end{matrix} ] = [ \begin{matrix}cos ( β ) & 0 & sin ( β ) \\ 0 & 1 & 0 \\ - sin ( β ) & 0 & cos ( β )\end{matrix} ] [ \begin{matrix}{\hat{e}}^{′} \\ \hat{ψ} \\ {\hat{z}}^{′}\end{matrix} ]$$

Using this information, \vec{l} can be further simplified:

\vec{l}=lê′=l cos(β)ê−l sin(β)\hat{z}

Now, the vector equation for \vec{a₂} can be simplified:

\vec{a₂}=Ω\hat{z}×(Ω\hat{z}×lê′)+\vec{a₁}.

\vec{a₂}=Ω\hat{z}×(Ω\hat{z}×(l cos(β)\hat{R}−l sin(β)\hat{z}))−eΩ²ê+\vec{a₀}

\vec{a₂}=Ω\hat{z}×(Ω\hat{z}×l cos(β)ê)−eΩ²ê+\vec{a₀}

\vec{a₂}=−l cos(β)Ω²ê−eΩ²ê+\vec{a₀}

\vec{a₂}=−(l cos(β)+e)Ω²ê+\vec{a₀}

However, \vec{a₂} must be represented in terms of the coordinate system of accelerometer 2 (e.g., its measurement axes). \vec{a₂} can be represented as the following vector quantity in terms of coordinates at the second accelerometer location, yielding:

\vec{a₂}=−(l cos(β)+e)Ω²(cos(β)ê′+sin(β)\hat{z}′)+\vec{a₀}

Furthermore, the system knows the following quantities: Ω is known from the tachometer; e and l are system parameters; \vec{a₀} is known from the first accelerometer. The flap angle β is not known.

If the a₂ acceleration is decomposed into its measurement axes, the following relationships can be obtained.

a₂ₑ′=\vec{a₂}·ê′=−(l cos(β)+e)Ω² cos(β)+\vec{a₀}·ê′

a_{2z}′=\vec{a₂}·\hat{z}′=(l cos(β)+e)Ω² sin(β)+\vec{a₀}·\hat{z}′

In the simplest case, it can be assumed that a₀ is negligible, which results in the following simplification:

a₂ₑ′=\vec{a₂}·ê′=−(l cos(β)+e)Ω² cos(β)

a_{2z}′=\vec{a₂}·\hat{z}′=−(l cos(β)+e)Ω² sin(β)

Now, a₂ₑ′ and a_{2z}′ are known quantities. Thus, these relationships can be used to determine the flap angle β. However, this process does not possess a closed form analytical solution and must be solved iteratively (which is easily possible using state of the art microcontrollers). For this first approach, a small flap angle β can be assumed which yields:

a₂ₑ′≅−(l(1−β²)+e)Ω²(1−β²)

a_{2z}′≅−(l(1−β²)+e)Ω²β

Neglecting terms higher than β³ yields the following simplifications:

a₂ₑ′≅[−(e+l)+(2l+e)β²]Ω²

a_{2z}′≅−(e+l)Ω²β

This trivially results in the following relationships for β in terms of accelerometer measurements taken at Accelerometer location 2.

$$β \tilde{=} \frac{{a}_{2 z}^{′}}{{Ω}^{2}} ( - \frac{1}{e + l} )$$

$$β \tilde{=} \sqrt{[ \frac{{a}_{2 e}^{′}}{{Ω}^{2}} + ( e + l ) ] ( \frac{1}{e + 2 l} )}$$

A similar derivation can be done for lead-lag angle (ζ) in terms of accelerometer measurements taken at Accelerometer location 2.

a₂ₑ′=\vec{a₂}·ê′=−(l cos(ζ)+e)Ω² cos(ζ)

a_{2ψ}′=\vec{a₂}·\hat{ψ}′=−(l cos(ζ)+e)Ω² sin(ζ)

When a small lead-lag angle ζ is assumed, the following equations result:

$$ζ \tilde{=} \frac{{a}_{2 ψ}^{′}}{{Ω}^{2}} ( - \frac{1}{e + l} )$$

$$ζ \tilde{=} \sqrt{[ \frac{{a}_{2 e}^{′}}{{Ω}^{2}} + ( e + l ) ] ( \frac{1}{e + 2 l} )}$$

FIG. 10 graphically illustrates the relationship between β and a₂ₑ′ and β and a_{2z}′, using simulated accelerometer measurements using realistic dimensions of a rotor head. Based on the simulated results in FIG. 10, using the accelerometer's vertical axis will give an approximately linear relationship with blade flap.

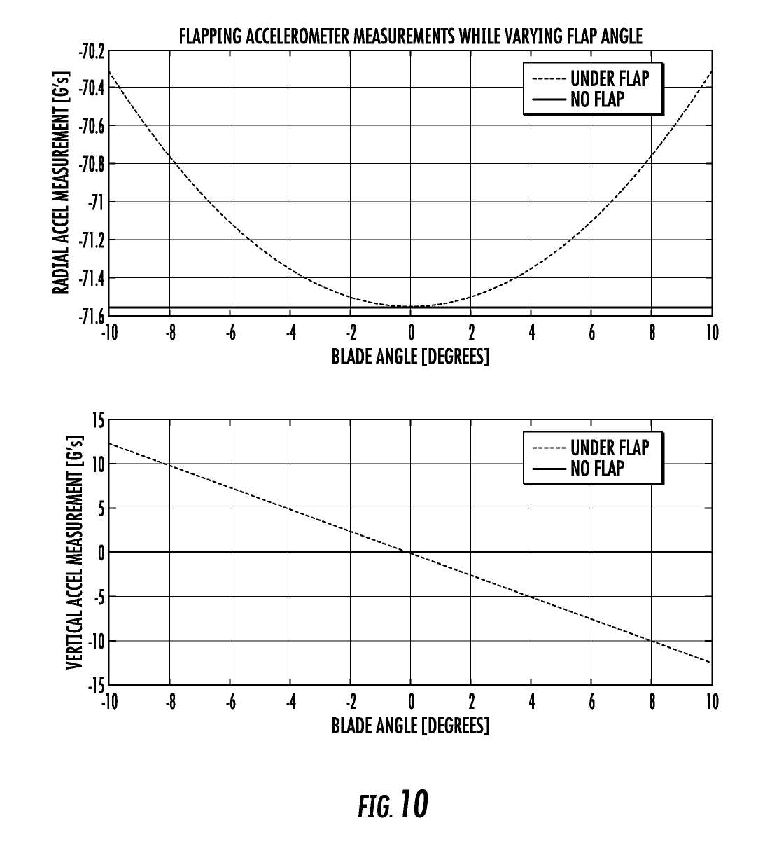

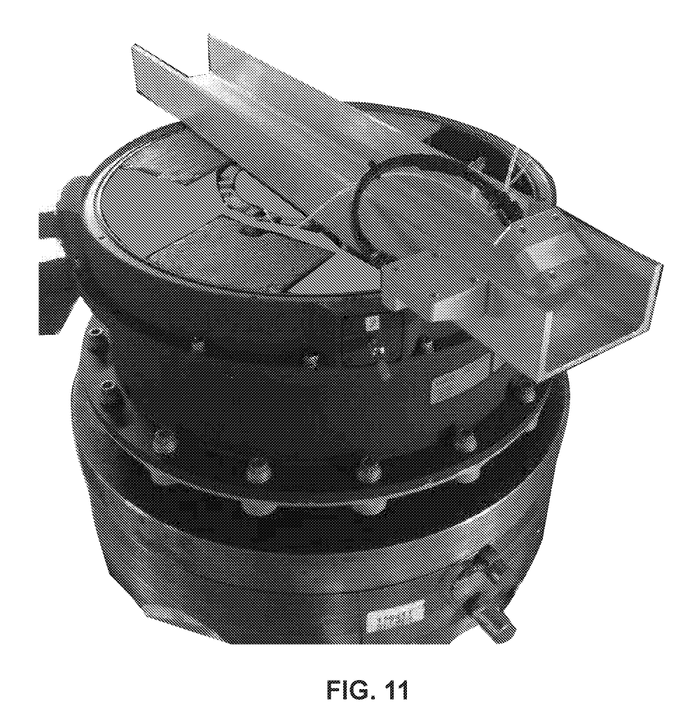

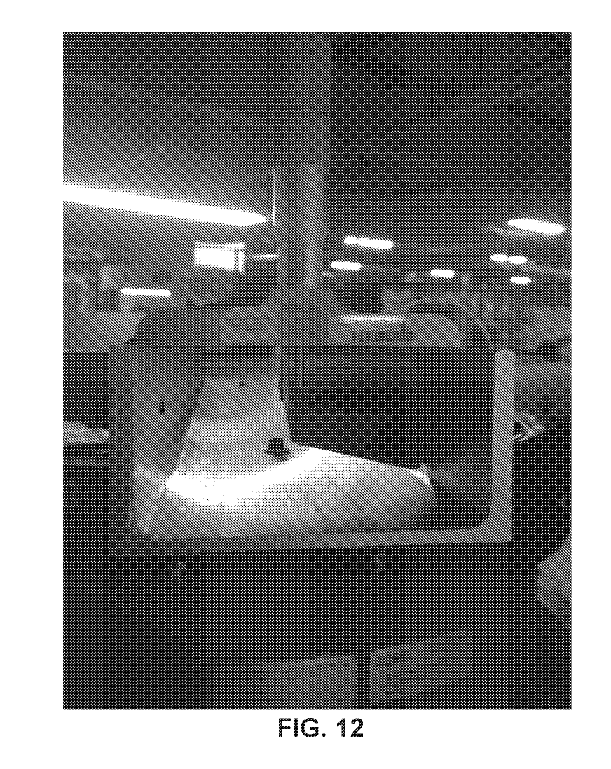

In order to provide reduction to practice of the subject matter described hereinabove, an empirical test on a helicopter fuselage was conducted, as is illustrated in FIGS. 11-12. The fuselage used was from a CH3 helicopter. On the rotating portion of the helicopter, a bracket was fabricated to set the accelerometers away from the center of rotation by approximately 10 inches, as is shown in FIG. 11. These accelerometers are measuring the acceleration and communicating digitally over a slip ring via a CAN bus interface. One accelerometer remained at a constant “flat” angle, and another accelerometer's angle was varied. The constant angle accelerometer simulates the accelerometer installed on the stationary side of the sensing system, while the variable angle accelerometer simulates the accelerometer installed on the movable side of the sensing system. The variable accelerometer's angle was measured using a depth gauge to obtain extremely accurate measurements, as illustrated in FIG. 12. Once the variable accelerometer's angle was measured, the system was spun up to a nominal speed of 4 Hz (close to a 1/Rev speed on a helicopter). This test procedure was repeated for different accelerometer angles and is summarized in FIG. 13.

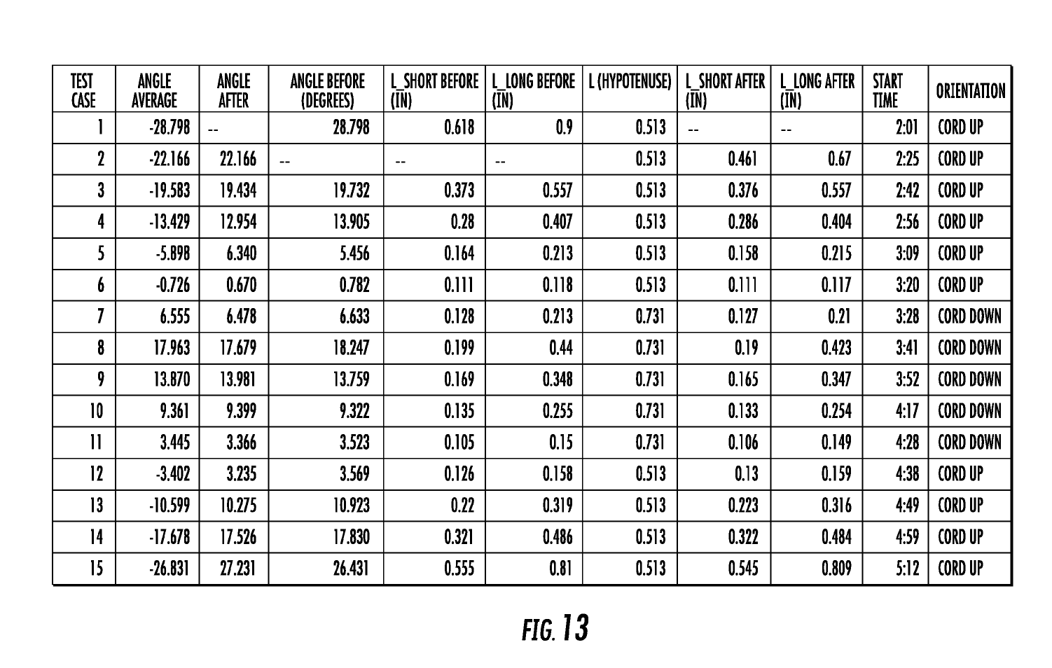

After analysis of the testing, experimental measurements on a real system with no applied external disturbance result in the following plots of measured acceleration versus “actual accel flap angle” in FIG. 14. These empirical results indicate that, as theoretically predicted, the differential accelerometer is suitable to measure flap angle in a real environment.

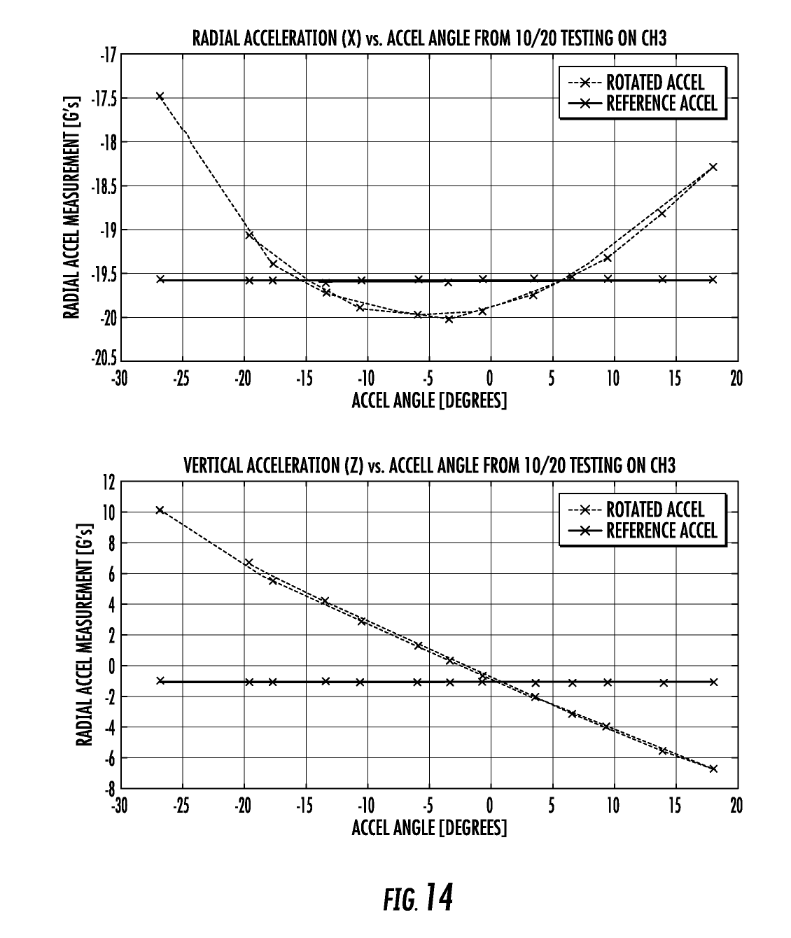

Referring now to FIG. 15, an embodiment of the main rotor bearing sensing system 1500 is illustrated. These sensors illustrated as being embedded within the bearings are displacement sensors, examples of which include an eddy current or DVRT sensor. The displacement sensor target can be any material and will naturally be optimized to provide the best sensitivity over the given design constraints of the application. In the embodiment 1500 shown, the displacement sensors shown are used to measure multiple different positions of the flapping, lagging, and/or pitching blade. Once measured, these positions can be used to solve a set of kinematic equations which allow a calculation of the orientation of the blade. The displacement sensor used for this task could be a traditional contacting DVRT, a non-contact DVRT, or a non-contact eddy current sensor. The contactless solutions operate by measuring the inductance or eddy current effects of a target material and correlate the relative change in inductance or eddy current effects to a displacement measurement. The contactless solutions do require the existence of a target material that is measurable, however, such solutions also provide a much less invasive installation for measuring positions of the blade.

Referring to FIGS. 16A and 16B, another embodiment of a sensing system includes magnetometers embedded within a bearing or bearing system 1600 and 1650 configured to measure the changing magnetic field due to movement of the bearings. One or more magnetometers 1602 can be placed on one side of the bearing 1600 and a magnet 1604 placed on the other side of the bearing 1600, as is shown in FIGS. 16A and 16B. As the end with the magnet 1604 moves relative to the end having the embedded magnetometer(s) 1602, the magnetometers 1602 detect fluctuations in the magnetic field and can be used to determine flap or lead-lag motion of the bearing. Careful placement of the magnetometers 1602 and magnets 1604 will also allow pitching motions (e.g., torsional deflection) to be measured. This measurement of pitching motions can be accomplished via an offset of the magnets from the centerline, or by detecting the motion of the magnetic poles.

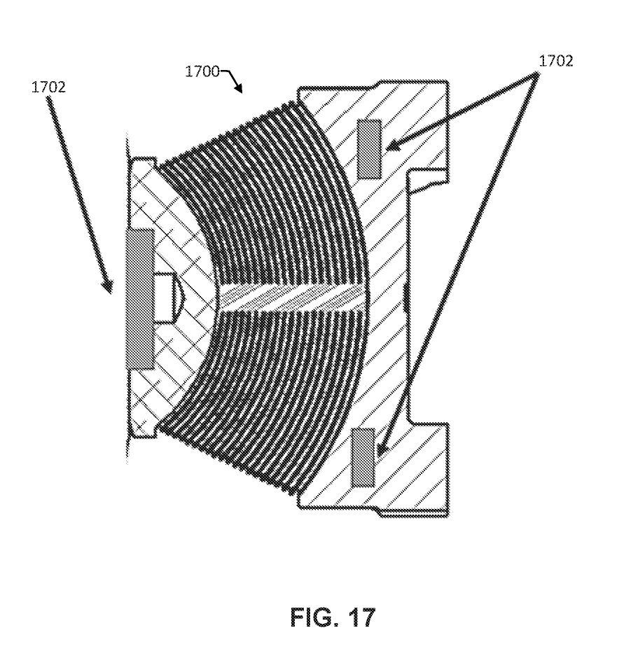

Another embodiment of a sensing system includes direct load measurement of forces transmitted through a structure of the helicopter bearing. Such loads transmitted due to flap, lead-lag, and pitch loads and moments can be read with a variety of sensors. Strain gages 1702 mounted on key locations around the bearing 1700, as illustrated in FIG. 17, can be characterized to determine the various load being transmitted through the part. The placement of such strain gages 1702 is dependent, at least to some degree, on the load to be measured. As such, the strain gages 1702 are applied to target specific directional loads transmitted through the bearing structure 1700. Post-processing of the strain data is then performed to convert it into flap, lead-lag, and pitch loads, but pre-processed data is suitable for use in determining useful life (and degradation) of the part. A neural network is one such way to process the data and can be incorporated into the control box 106. Similarly, torque sensors can be used to directly measure torque. Since such sensors are specifically designed to detect torque, it is advantageous for some applications to use such torque sensors instead of using strain gages to calculate a torque value. Torque sensors can be incorporated into the bearing to measure pitch or, in the distributed sensor network, to measure torque on drive shafts or other similar components.

In some embodiments, tachometers are incorporated into the distributed sensing network to read rotor speed at the main rotor drive shaft or to read the rotational speed of other rotating equipment on the rotorcraft.

Temperature sensors (e.g., thermocouples, thermometers, etc.) are suitable for inclusion in some embodiments and can be incorporated in the distributed sensor network to detect overall aircraft or environment temperature to detect temperatures in key locations and/or can be incorporated into the bearing or bearing system. Incorporating thermal sensors into the bearing allows the controller to adjust the post processing to account for temperature effects in either the parts or in other sensors in the bearing. Thermal sensors can be coupled with other sensors to help adjust for any thermal variability.

Embedded sensing is useful across many platforms. The devices described in this specification can be used to monitor health of the individual component, the subsystem of which the component is a member, up to the entire vehicle or system. Additionally, when used in conjunction on multiple vehicles, the data from these embedded sensing systems can be used to monitor fleet health and usage and be used to make judgements on individual vehicle performance using statistics or other big data analysis.

Aside from health and usage monitoring, these embedded sensing systems can be used to actively monitor subsystem or system states and provide feedback to that system. Examples include embedded sensing dampers that can provide blade motion feedback to the pilot, crew, or flight control system that can then in turn adjust rotor performance. In some instances, the feedback can cause changes in the same component, such as in the case of an active damper, while in others, a different system component can be actuated to alter the system behavior, such as in the case of active pitch links on a helicopter.

Another example would include embedded sensing on an undersea bearing that can monitor angular deflection that could feed back into the oil platform controller to adjust for platform motion. Still another example would use embedded sensing on suspension mounts to determine loading of the vehicle, which could be used to determine carried weight, weight distribution, or even ground contact. There are many applications where embedded sensing can provide loads, motions, temperatures, accelerations, or any combination of the previous to determine system and vehicle health, usage, and state.

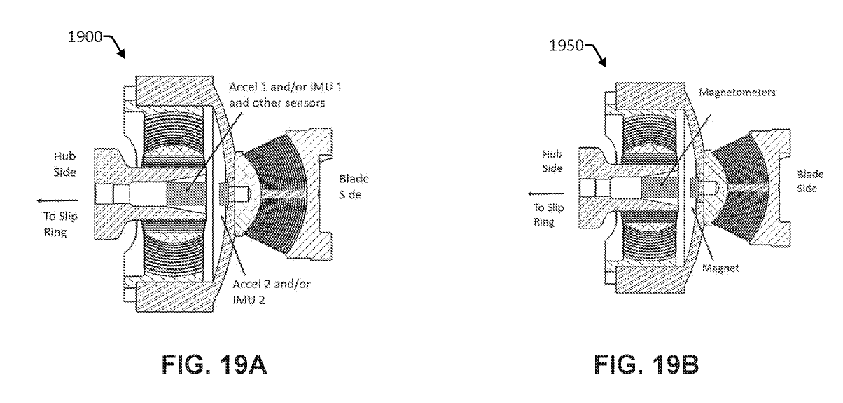

For example, embedded sensing can be used in bearings such as high capacity laminate (HCL) elastomeric bearings. FIG. 19A is a cross-sectional view of an example bearing 1900 illustrating embedded sensing using accelerometers. HCL bearings can be used in many applications including on rotorcraft, in fixed wing aircraft, in oil and gas applications, as well as in many vehicle designs. These bearings generally accommodate motion in 1 or more directions including compression, torsion, shear, or cocking about 1 or more axes. To capture this motion, there are a series of embedded sensing configurations that have been designed and tested, both in the analytic environment as well as physical prototypes.

Accelerometers have proven very effective when used in a differential configuration. When placed on either end of an HCL bearing, e.g., as shown in FIG. 19A, the differential acceleration across the elastomer section can be used to determine motion. In place of accelerometers, inertial measurement units can perform a very similar function when used in a differential configuration on either end of the elastomer section. A series of 1 or more accelerometers can also be used on a single side of a bearing to determine relative motion. Either accelerometer configuration, when incorporated into a moving vehicle, such as in a helicopter rotor system, can use the differential measurements between the two or more accelerometers to cancel out the vehicle or system motion to target the bearing motion, or can use the same information to determine vehicle or system motion in addition to the bearing motion.

FIG. 19B is a cross-sectional view of an example bearing 1950 illustrating embedded sensing using magnetic sensors. Magnetometers and other magnetic sensors, such as hall effect sensors, can also be used to determine motion in an HCL bearing. If the magnets are placed on one side of the elastomer section and the magnetic sensor is placed on the other, e.g., as shown in FIG. 19B, the varying magnetic field can be used to determine motion in all directions. A series of magnetometers or magnets and carefully chosen placement can used for providing unique magnetic fields for all motions. Typically, the more magnets or sensors that are used, the easier it is to create a unique magnetic field for all motions. Angular magnetic sensors are useful where the sensor can be put in close proximity to the magnet, allowing complete saturation of the sensor. This improves resistance to noise from external sources. In some embodiments, the magnetic sensor and magnet are housed within an enclosed metallic structure.

DVRTs, LVDTs, contactless DVRTs, as well as visual sensors and differential inertia sensors are all useful sensing devices to be incorporated into HCL bearings, e.g. as shown in FIG. 3. These generally require attachment to one end of the bearing and either contact or close proximity to the other end to pick up movement. Visual sensors, such as lasers, light reflective sensors, or visual distortion sensors can be used at more of a distance, but may require a sealed cavity to prevent noise from contamination.

In addition to mounting any of the above sensors solely on the bearing, these sensors, especially in the case of the accelerometer, visual, or magnetic sensor configurations, can be mounted on surrounding system geometry. This is also true for the contact or proximity sensors such as the DVRTs, LVDTs, and inertia sensors, though the mounting of these sensors usually must still allow full bearing motion which can be difficult to achieve.

Load measurements can also be useful in bearing configurations. Load cells can be put in series with these devices as is done in many applications, but that is not always feasible. Embedded strain gages can readily be used to determine loads, e.g., as shown in FIG. 17. Appropriate placement of the strain gages can allow discrete measurement of the loads in single axis configurations, while more complex configurations can be used to measure multi-degree of freedom loads. Configurations of strains gages can be used to measure compression and shear loads as well as torsion and cocking moments. These strain gages can either be incorporated on the surface of metal components, or specific pockets can be made to house the gages to more accurately align stress fields. Analysis of the components during sensor design can help to target the best strain gage placement and configuration.

In addition to load and motion, temperature measurements can be useful to monitor. Simple thermal couples can be used measure temperature both around the part and at key locations within the part. More complex detection sensors, such as corrosion, moisture, or even individual substance sensors can of course be added.

In an embedded sensing HCL bearing, any configuration of the above listed sensors can be used in conjunction. In one simple configuration a temperature sensor may be incorporated to detect over heating conditions of the part or nearby components. In another configuration, a temperature sensor is included with a single axis magnetometer and strain gage to accurately determine compression load and motion, using the temperature data to correct for changes in the data due to temperature. In a complex configuration, full 6 degree of freedom motion, 3 degree of freedom loads, and 3 degree of freedom moments, as well as temperature and corrosion sensing are all embedded within the bearing.

In some instances, this data can be handled by a simple onboard processor, or be sent either by wire or wirelessly to an off bearing processor. In either case, it may be useful to use complex transfer functions or neural networks to go from the raw sensor output to real motions and loads. These have been proven to be very effective in multiple test prototypes. Training is conducted on a known data set to configure the transfer function or neural network. Then the embedded sensing part is validated against a different data set.

The embedded sensing bearing can use either on-board power, batteries, system power supplied from outside of the bearing, including near field wireless transmission, as well as from energy harvesting. The energy harvesting configurations can include kinetic harvesters, such as vibration activated devices, thermal harvesters, such a thermal electric generators, or other systems.

Data collected by the sensors can be processed on the bearing or off the bearing. The data collected can either be transmitted via wires, wireless technology, or stored on the bearing until accessed. In one configuration, a NFC wand can be used to power the bearing and collect data from the bearing. Wireless protocols can be used transmit raw sensor data or processed data either to a nearby receiver, or one in a disparate part of the system.

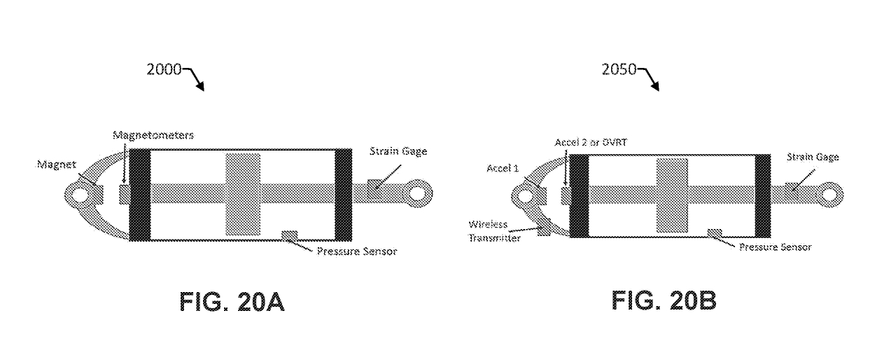

Another example of embedded sensing includes damper and isolator configurations. FIG. 20A is a cross-sectional view of an example fluid-elastic damper 2000 with embedded sensing. FIG. 20B is a cross-sectional view of an example fluid-elastic pylon isolator 2050 with embedded sensing.

In general, damper and isolator configurations can be elastomer based, fluid based, or fluid-elastic based. These devices generally translate in one direction, though in some instances can be used in multiple dimensions. In the single axis configurations, motions are generally linear or rotary. Similar to the embedded sensing described in the embedded sensor HCL bearings, all of the same sensors, power, energy harvesting, wireless or wired transmission, and data processing apply. In the single axis configurations, these motions and loads are generally simpler since only direction is required.

Additionally, pressure sensors can be incorporated into the fluid devices to monitor pressure in active, passive, and volume compensation chambers. These can be used in conjunction with the previously mentioned sensors or on their own. They can be used to monitor load directly, or calculate a motion, or determine proper fill and pressure charge. In an example configuration shown in FIG. 20A, a linear lead-lag damper has a strain gage single axis load sensor, a differential accelerometer based motion sensor, and a temperature sensor that is used to monitor thermal conditions. In another configuration shown in FIG. 20B, a fluid-elastic isolator has a pressure sensor to monitor the internal fluid pressure, a thermal electric generator to provide power to the sensors, and a wireless transmission system. In still another configuration, a simple elastomeric isolator contains a magnetometer and magnet to measure deflection. A system can mix these load, motion, temperature, communication, power, and processing options into multiple configurations based on the end need.

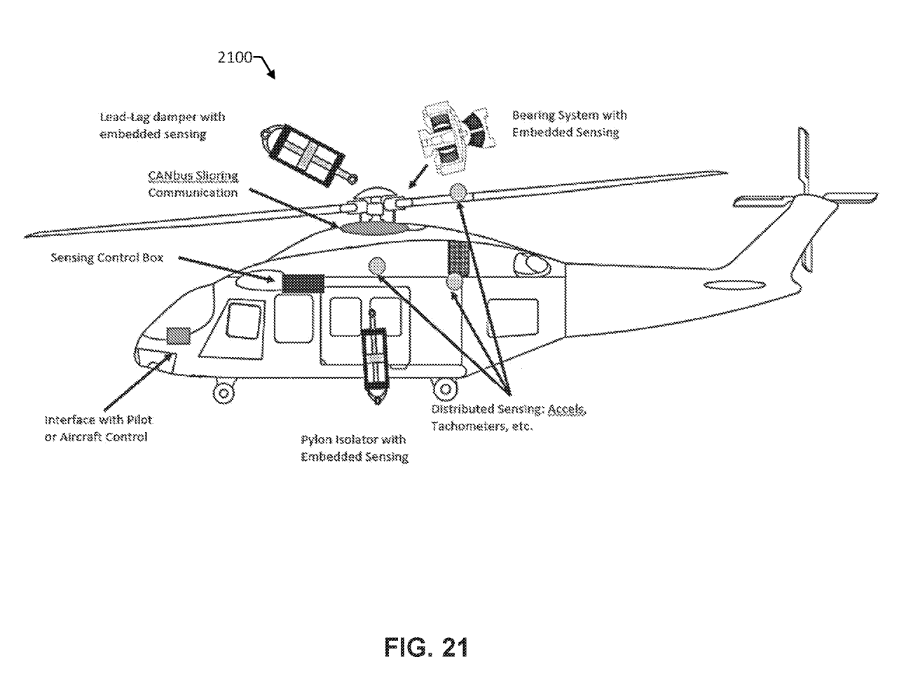

FIG. 21 is a schematic diagram illustrating an example helicopter 2100 with integrated embedded sensors and distributed sensors. Each embedded sensing component can be incorporated into the overall system to provide holistic health, usage, or current status view of the system. Not only can the embedded sensing components be used, but distributed sensing systems can be incorporated into the system as well. Accelerometers on the rotor blades can be used to determine deflection along the blade in addition to the deflection of the bearing at the root of the blade. Strain gages at the base of a wing can be used to determine overall loads, while an isolator on a critical component within the wing can transmit the loads and motions at that specific location.

With a complete picture of loads and motions of the system and critical components, operators or computers can make on the fly decisions about usage, risk levels, as well as provide adaptive control to the system. In one such configuration, an embedded sensing bearing communicates to a pilot and a flight control computer about excessive blade motions through a slip-ring. The flight control computer can then send a signal to an active lead-lag damper to increase damping to reduce the excessive lead-lag motions.

The subject matter disclosed herein can be implemented in or with software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter. For example, although the above discussion relates to sensing systems for rotorcraft having elastomeric bearings, those of ordinary skill in the art will understand that similar principles and arrangements may be applied to any structures which have a variable degree of movement therebetween.

What is claimed is:

1. A method for sensing motion in a rotary aircraft, the method comprising:
distributing one or more sensors within a rotating hub and/or rotor blade;
transmitting output values from the one or more sensors to a controller; and
computing at least one aspect of movement for the rotor blade using the output values.

2. The method of claim 1, wherein the one or more sensors include one or more of accelerometers, DVRTs, strain gages, piezo electric sensors, magnetometers, tachometers, torque sensors, temperature sensors, and inertial measurement units (IMUs).

3. The method of claim 1, wherein the at least one aspect of movement being computed comprises one or more of a flap angle, a lead-lag angle, a pitch angle, a linear displacement, and a blade deflection.

4. The method of claim 1, wherein the one or more sensors comprise:
a first sensor on a stationary side of the rotating hub; and
a second sensor on a movable side of the rotating hub, and
wherein the at least one aspect of movement for the rotor blade is computed by differential analysis of the output values by a control box.

5. The method of claim 1, wherein the one or more sensors are distributed along a length of a rotor blade.

6. The method of claim 1, further comprising a step of transmitting the at least one aspect of movement for the rotor blade to a flight control system by a data bus of the rotary aircraft.

7. The method of claim 1, further comprising a step of communicating the at least one aspect of movement to a crew member and/or pilot of the rotary aircraft via aural, tactile, or visual feedback.

8. A distributed sensing system for detecting blade motion on an aircraft having a plurality of rotor blades, the system comprising:
a plurality of sensors associated with each of the plurality of rotor blades, each of the plurality of sensors being configured to detect motion in a respective rotor blade; and
a controller configured to receive signals from the plurality of sensors and in electronic communication with the flight control system across a data bus of the aircraft.

9. The system of claim 8, wherein the flight control system is configured to execute at least one maneuver control limit and/or communicate one or more threshold limit warnings to a pilot based on a blade motion detected by at least one of the plurality of sensors.

10. A sensor system for detecting at least one aspect of movement across an articulating joint, the system comprising:
a rotary hub;
a plurality of rotor blades;
at least one first sensor disposed on a first side of the rotary hub and configured to generate a first output signal;
at least one second sensor on a second side of the rotary hub and configured to generate a second output signal; and
a control box in electrical communication with the at least one first and second sensors to a data bus.

11. The sensor system of claim 10, wherein the first side of the rotary hub is fixed with respect to the aspect of rotary motion to be measured and the second side of the rotary hub is movable with respect to the aspect of rotary motion to be measured.

12. The sensor system of claim 10, wherein the at least one first sensor and the at least one second sensor are disposed at different distances in substantially a same radial direction.

13. The sensor system of claim 10, wherein the system is configured to measure a flap angle of one or more of the plurality of rotor blades.

14. A sensor system for measuring motion across an articulating joint including a plurality of members with an articulation device therebetween, the sensing system comprising:
at least three motion measuring devices affixed to each of the plurality of members and proximal to the articulation device, the at least three motion measuring devices each being configured to create a respective output signal;
a control box in electronic communication with the at least three measuring devices and configured to receive the output signal from each of the at least three motion measuring devices, wherein the control box is configured to process and combine the respective output signals and resolve three degrees-of-freedom of articulation.

15. A sensing system comprising:
a plurality of sensors in a rotating and/or fixed frame, each of the plurality of sensors being configured to synthesize sensor data; and
a control box in electronic communication with the plurality of sensors and configured to receive the synthesized sensor data, wherein the controller is configured to use the sensor data to determine an orientation of at least one rotor blade.

16. The system of claim 15, wherein the orientation comprises at least one of pitch, lead-lag, and flap angle.

17. The system of claim 15, comprising a digital bus on an aircraft, wherein the system is configured to communicate on the digital bus and relay the orientation of the at least one rotor blade to a flight control computer or a crew member of an aircraft.

18. A blade motion and load detection system comprising:
a rotary wing aircraft comprising:
a rotary hub,
a plurality of rotor blades,
at least one bearing system configured to provide articulation between the rotor hub and each of the plurality of rotor blades;
a data transfer system, and
a flight control system; and
a distributed sensing system comprising:
at least one sensor in at least one of the at least one bearing system, the at least one sensor being configured to detect load and/or motion,
a control box configured to receive signals from the at least one sensor,
a database configured to store the signals received, and
a communication bus configured to communicate data from the control box to the flight control system.

19. The blade motion and load detection system of claim 18, wherein the flight control system is configured to:
provide an indication to a crew member via at least one of visual, auditory, and tactile feedback;
communicate information from the control box of the distributed sensing system; and/or
alter allowed flight conditions based on input from the control box of the distributed sensing system.

20. The system of any of the claims above, wherein the plurality of sensors comprise one or more of differential accelerometers, distributed accelerometers, DVRTs, eddy current sensors, inertial measurement units, strain gages, piezo electric sensors, magnetometers, tachometers, torque sensors, and temperature sensors.
